(19) United States
(12) Patent Application Publication
(10) Pub. No.: US 2018/0013869 A1
(43) Pub. Date: Jan. 11, 2018

(54) INTEGRATION OF VOIP PHONE SERVICES WITH INTELLIGENT CLOUD VOICE RECOGNITION

(71) Applicant: Vladimir Smelyansky, Glenview, IL (US)

(72) Inventor: Vladimir Smelyansky, Glenview, IL (US)

(21) Appl. No.: 15/641,140

(22) Filed: Jul. 3, 2017

Related U.S. Application Data
(60) Provisional application No. 62/359,611, filed on Jul. 7, 2016.

(51) Int. Cl. H04M 1/27; H04M 1/67; H04M 3/42; H04M 3/436; H04M 3/51; H04M 11/04; H04M 1/57; H04M 3/56; H04M 3/527; H04M 7/00; H04M 11/10

(52) U.S. Cl. CPC H04M 1/271; H04M 7/006; H04M 1/67; H04M 3/42059; H04M 3/436; H04M 11/10; H04M 11/045; H04M 1/578; H04M 3/56; H04M 3/527; H04M 3/5116; H04M 2201/40; H04M 2203/5018; H04M 2203/6054; H04M 2242/04

(57) ABSTRACT

Integration of VoIP phone services with Intelligent Cloud Voice Recognition for emergency services overcomes limitations of conventional residential telephone technology to inexpensively provide more useful and advanced residential telephone services. For example, in an embodiment, a communication method may comprise establishing a communications session between either a user device and a telephone system or between a user device and voice recognition system, if the communications session is between a user device and a telephone system, extending the communications session to include a voice recognition system, if the communications session is between a user device and a voice recognition system, extending the communications session to include a telephone system, providing voice or speech information to the voice recognition system from the user device, and performing at least one function with the voice recognition system based on the provided voice or speech information.

### CROSS-REFERENCE TO RELATED APPLICATIONS

This application claims the benefit of Provisional Application No. 62/359,611, filed Jul. 7, 2016, the contents of which are incorporated herein in their entirety.

### BACKGROUND OF THE INVENTION

### 1. Field of the Invention

The present invention relates to integration of VoIP phone services with Intelligent Cloud Voice Recognition for emergency services.

### 2. Description of the Related Art

There are currently available different Intelligent Cloud Voice Recognition (ICVR) services, such as APPLE SIRI®, OK GOOGLE®, AMAZON ALEXA®, etc. While the primary goal for these services is to be as universal as possible with major emphasis on the Internet search capabilities, they also can be optimized to do specific tasks. The deeper integration of any them with one or a few particular services could provide some additional functionality originally not available or not easy to use with default offering.

For example, a user must have a separate phone device from OOMA® and an ALEXA® enabled device, such as the AMAZON ECHO® device to make a phone call. The actual integration from the user end is awkward as well. For example, a user must ask ALEXA® to make a phone call and ALEXA® would initiate a call from an OOMA® device. So, a user must use and speak to both the ECHO® device and to the phone in order to make a phone call. Such a solution does not provide an improved user experience over just using a telephone. As a partial solution, an AMAZON ECHO DOT® device may be used in addition to the phone in every location in which service is intended to be provided. There are also third party devices that are trying to resolve such issues, such as INVOXIA®, TRIBY® and others.

Among other issues, there is a problem when attempting to make an emergency call, for example. The ICVR, such as ALEXA®, cannot by itself make an emergency call, but a telephone can. For example, to make an emergency call, the physical user location has to be provisioned with the calling service, which is not part of ICVR offering. At the same time phone service providers have all that information and are capable of providing such information.

A need arises for a technique by which limitations of conventional residential telephone technology may be overcome to inexpensively provide more useful and advanced residential telephone services.

### SUMMARY OF THE INVENTION

Integration of VoIP phone services with Intelligent Cloud Voice Recognition for emergency services overcomes limitations of conventional residential telephone technology to inexpensively provide more useful and advanced residential telephone services. For example, embodiments of the present systems and methods may provide the capability for existing phones to be usable ICVR or other VoIP phone service, enabled devices, for emergency calls and services, as well as for regular calls. Such a solution would not only save money on additional devices, it would also reduce amount of gadgets that one has to keep, configure, and maintain. Likewise, the need to learn how to operate the additional devices would also be reduced.

In an embodiment, a communication method may comprise establishing a communications session between either a user device and a telephone system or between a user device and voice recognition system, if the communications session is between a user device and a telephone system, extending the communications session to include a voice recognition system, if the communications session is between a user device and a voice recognition system, extending the communications session to include a telephone system, providing voice or speech information to the voice recognition system from the user device, and performing at least one function with the voice recognition system based on the provided voice or speech information.

In embodiments, the provided voice or speech information may be extracted from voice or speech information otherwise directed to the telephone system. The provided voice or speech information may indicate a call recipient, and the voice recognition system may perform a function of initiating a call over the telephone system to the call recipient. The provided voice or speech information may be an incoming call to the user device, and the voice recognition system may perform a function of screening the incoming call. Screening the incoming call may comprise determining if an Automatic Number Identification (AM) of the incoming call is approved, authorized, or verified, and if the Automatic Number Identification (ANI) of the incoming call is not approved, authorized, or verified, ask the caller for information relating to the call. The provided voice or speech information may be security information from the user device, and the voice recognition system may perform a function of verifying the security information. The security information may comprise biometrically verifying an identity of a speaker of the security information, if the identity of the speaker of the security information is verified with a high level of trustworthiness, verifying the security information, and if the identity of the speaker of the security information is not verified with a high level of trustworthiness, further verifying the security information. The provided voice or speech information may be emergency information from the user device, and the voice recognition system may perform a function of requesting emergency services. The method may further comprise detecting a security breach, and the voice recognition system may perform functions of: performing a dialog with a person involved in the security breach, wherein the provided voice or speech information is from the person involved in the security breach, and requesting emergency services. The provided voice or speech information is information indicating a call to be placed from the user device, and the voice recognition system performs a function of initiating the indicated call over the telephone system.

In an embodiment, a computer program product for performing a communication method may comprise a non-transitory storage medium and computer program instructions recorded thereon for performing the method comprising establishing a communications session between either a user device and a telephone system or between a user device and voice recognition system, if the communications session is between a user device and a telephone system, extending the communications session to include a voice recognition system, if the communications session is between a user device and a voice recognition system, extending the communications session to include a telephone system, providing voice or speech information to the voice recognition system from the user device and performing at least one function with the voice recognition system based on the provided voice or speech information.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is a block diagram of an exemplary communication environment, in which embodiments of the present invention may be implemented.

FIG. 2 is a flow diagram of an exemplary communication process, in accordance with embodiments of the present invention.

FIG. 3 is an exemplary block diagram of a computing device, in which embodiments of the present invention may be implemented.

### DETAILED DESCRIPTION OF THE INVENTION

Integration of VoIP phone services with Intelligent Cloud Voice Recognition for emergency services overcomes limitations of conventional residential telephone technology to inexpensively provide more useful and advanced residential telephone services. For example, ICVRs, such as ALEXA®, may provide a more intelligent front end for inbound calls. For example, instead of asking to dial a user extension, a user may provide the ICVR with the name of the call recipient, and the ICVR can find the proper recipient by name. Further, an ICVR may provide incoming call screening in a “human” way. For example, if the Automatic Number Identification (ANI) incoming call is not listed on a white list, the ICVR can ask the caller for identification and the reason for the call. This may be done so that the caller may not recognize that it was not a real person that answered the call. After obtaining the information, the ICVR may ring the user phone or present the called party with options, such as “you have a call from the insurance agency, do you want to take it?” With proper configuration, the ICVR may filter unsolicited and fraudulent calls even while they are delivered to the called party.

Current home security systems are utilizing keypads and require user to enter the passcode on each entrance/exit. This presents usability difficulties. With an ICVR, the user can use a secret phrase. Further, the ICVR provider can use voice biometrics to identify the legitimate user. For example, the user could say the phrase “Alexa it is me” instead of the secret code/phrase and, if the biometric doesn't verify the user with a high trustworthiness level of identification, the ICVR may ask for the secret phrase.

In embodiments, the present invention may provide the capability to provide Emergency services from ICVR enabled devices, such as the AMAZON ECHO®, etc., by utilizing already existing E911 services provided by VoIP or other phone service providers.

In embodiments, the present invention may provide the capability to add an ICVR service or an ICVR enabled device as the third leg to a phone call, such, for example, three-way-calling, or to “invite” an ICVR service or an ICVR enabled device to a conference bridge that enables interactive use of the ICVR during a phone conversation.

In embodiments, the present invention may provide the capability to use an ICVR service or an ICVR enabled device as a component of a security system. Such a system may include usage of voice biometrics to identify the proper user or home owner. Motion detection devices may be connected to the ICVR enabled device in order to use automatic 911 service provided by a phone company, without the need for an additional security service.

In embodiments, the present invention may provide the capability to use an ICVR service or an ICVR enabled device as a component in a security system that can start dialog with an intruder or trespasser. Likewise, such a system may take other actions, such as turning on/off the lights or closing the doors or the like to give the impression that there is a real person in the house, while the emergency services are being contacted.

In embodiments, the present invention may provide the capability to use an ICVR service or an ICVR enabled device as the front assistant for inbound calls, including providing a family/corporate directory service for the caller, as well as intelligent call screening for different purposes, including identification of solicited and fraudulent calls.

In embodiments, the present invention may provide the capability to use an ICVR service or an ICVR enabled device to access password protected phone features, such as voicemail, by using voice biometrics with or without a secret phrase.

In embodiments, the present invention may provide the capability to use voice biometrics to limit access to restricted services, including child protection for example.

In embodiments, the present invention may provide the capability to use the combination of third party voice biometrics with ICVR to provide secure or restricted services. For example, the ICVR service or ICVR enabled device may inform a phone service provider that service requires authentication, the phone service provider would contact a biometric service provider and provides confirmation/rejection/trustworthiness back to the ICVR service or ICVR enabled device. In response, the ICVR service or ICVR enabled device may make a decision to allow the service or ask for a password.

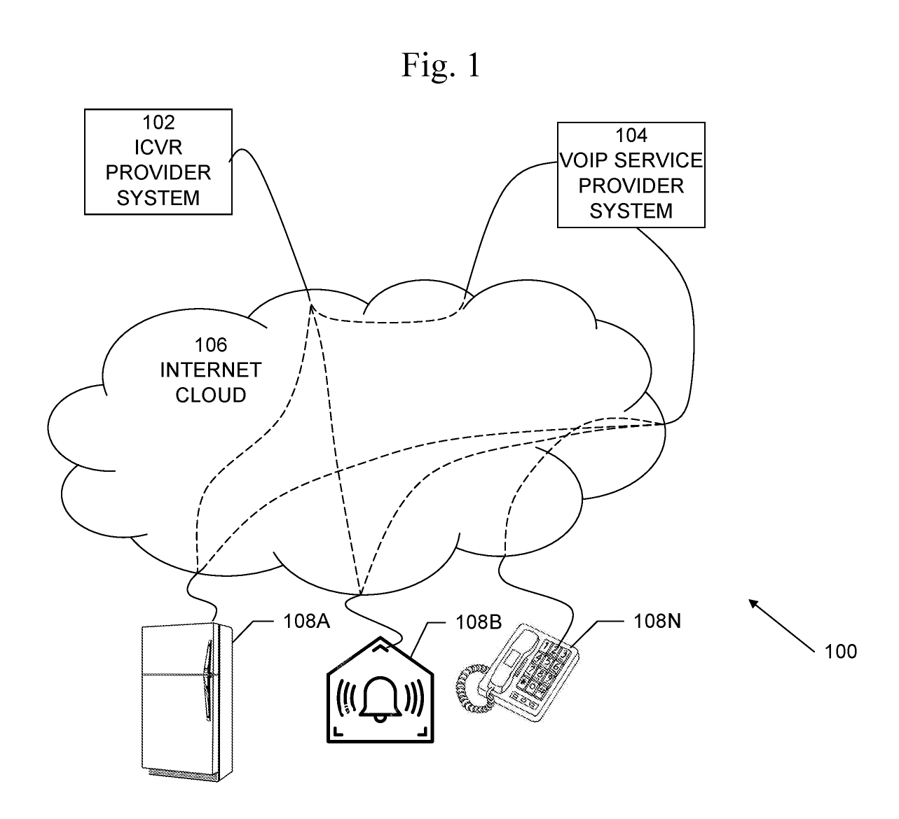

An exemplary communication environment 100 is shown in FIG. 1. In this example, distributed communication environment 100 may include one or more Intelligent Cloud Voice Recognition (ICVR) provider systems 102, one or more Voice-over-Internet Protocol (VoIP) provider systems 104, an Internet Cloud 106, and a plurality of Internet-connected, voice enabled user devices 108A-N.

ICVR provider systems 102 may be used to add intelligent voice control to any connected device that has a microphone and speaker. ICVR provider systems 102 are typically cloud-implemented speaker independent voice recognition and response systems that also may perform other Internet-connected functions. VoIP provider systems 104 provide the capability for the delivery of voice communications and multimedia sessions over Internet Protocol (IP) networks, such as the Internet. User devices 108A-N may include any connected device that has a microphone and speaker and is capable of at least audio communications over a network, such as the Internet. User devices 108A-N may communicate using VoIP or any other proprietary or non-proprietary protocol. Examples of user devices 108A-N may include telephones, Internet-connected household appliances, such as refrigerators, thermostats, etc., Internet-connected security devices, such as alarm boxes, motion detectors, window sensors, etc., or any other type of Internet-connected device that may communicate audio, video, or data. Typically, telephones, such as 108N, are VoIP phones or analog phones connected to the Internet using an analog telephone adapter. An analog telephone adapter is a device used to connect one or more standard analog telephones to a digital telephone system (such as Voice over IP) or a non-standard telephone system over a data network. Such devices may be used to provide Voice-over-IP (VoIP) telephone service.

In the example shown in FIG. 1, an ICVR provider system 102 may be added as a third leg to a phone call. For example, telephone 108N may be communicating with VoIP provider system 104 and ICVR provider system 102 may be added using three-way-calling, as shown, or using a conference bridge (not shown). In either case, adding ICVR provider system 102 as a third leg to the phone call enables interactive use of the ICVR during a phone conversation. Likewise, appliance 108A or security device 108B may be communicating with VoIP provider system 104, and ICVR provider system 102 may be added using three-way-calling, as shown, or using a conference bridge (not shown). In either case, adding ICVR provider system 102 as a third leg to the phone call enables interactive use of the ICVR during a the conversation using appliance 108A or security device 108B.

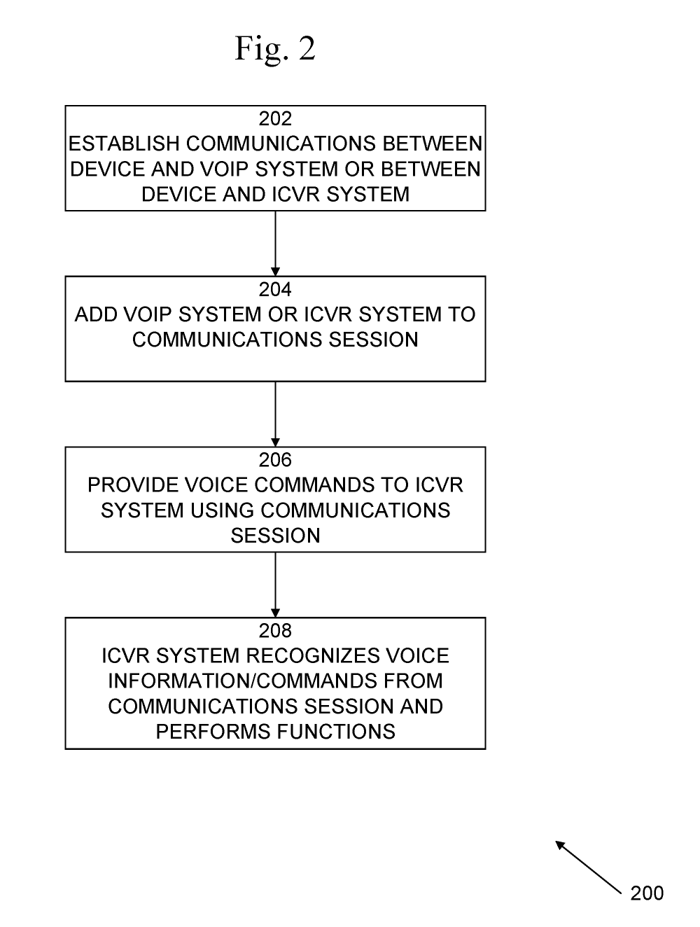

An exemplary flow diagram of a process 200 of integration of VoIP phone services with ICVR is shown in FIG. 2. It is best viewed in conjunction with FIG. 1. Process 200 begins with step 202, in which a first leg of the overall communications session may be established. For example, a communications session may be established between a user device 108A, 108B, 108N, and VoIP provider system 104, or a communications session may be established between a user device 108A, 108B, 108N, and ICVR provider system 102. Either type of communication session may be established as the first leg of the overall communications. The present invention is applicable to either type of communication session being established as the first leg.

In step 204, the second leg of the overall communications session may be established by adding the VoIP provider system 104 or the ICVR provider system 102 to the communication session. For example, if a communications session is established between a user device 108A, 108B, 108N and VoIP provider system 104 as the first leg of the communications session, then the ICVR provider system 102 is added to the communication session. Likewise, if a communications session is established between a user device 108A, 108B, 108N and ICVR provider system 102 as the first leg of the communications session, then VoIP provider system 104 is added to the communication session. In embodiments, the present invention may provide the capability to add an ICVR service or an ICVR enabled device as the third leg to a phone call, such, for example, three-way-calling, or to “invite” an ICVR service or an ICVR enabled device to a conference bridge that enables interactive use of the ICVR during a phone conversation.

In step 206, voice commands are provided to ICVR provider system 102 using the communications session. Such voice commands may be directed to ICVR provider system 102, or they may be extracted from conversation otherwise directed to VoIP provider system 104. In step 208, ICVR provider system 102 may recognize voice information/commands from communications session and may perform functions in response.

For example, in an embodiment, in step 206, a user may use any of user devices 108A, 108B, 108N to provide ICVR provider system 102 with the name of a call recipient, and, in step 208, ICVR provider system 102 may recognize the call recipient and transmit commands to VoIP provider system 104 to initiate a call to that recipient in response to the name.

In an embodiment, ICVR provider system 102 may provide incoming call screening in a “human” way. For example, in an embodiment, in step 206, an incoming call to any of user devices 108A, 108B, 108N may be directed to ICVR provider system 102. In step 208, if the Automatic Number Identification (ANI) of the incoming call is not listed on a white list or otherwise approved, authorized, or verified, ICVR provider system 102 may ask the caller for identification and the reason for the call. Further, this may be done so that the caller may not recognize that it was not a real person that answered the call. After obtaining the information, the ICVR may ring the user phone or present the called party with options, such as “you have a call from the insurance agency, do you want to take it?” With proper configuration, the ICVR may filter unsolicited and fraudulent calls even while they are delivered to the called party.

In an embodiment, in step 206, a user device, such as security device 108B may receive a secret phrase or other voice sample from a user and provide the secret phrase or other voice sample ICVR provider system 102. In step 208, the ICVR provider may use voice biometrics to identify the legitimate user. For example, the user could say the phrase “Alexa it is I” instead of the secret code/phrase and, if the biometric verify the user with a high trustworthiness level of identification, the ICVR may ask for the secret phrase. Further, motion detection devices may be connected to the ICVR enabled device in order to use automatic emergency calling services provided by a phone company, without the need for an additional security service.

In embodiments, the present invention may provide the capability to provide Emergency services from ICVR enabled devices, such as the AMAZON ECHO®, etc., by utilizing already existing E911 services provided by VoIP or other phone service providers. For example, in step 206, a user may use any of user devices 108A, 108B, 108N to provide ICVR provider system 102 with a request for emergency services, and, in step 208, ICVR provider system 102 may recognize the request and transmit commands to VoIP provider system 104 to initiate a call to that emergency services in response to the request.

In embodiments, the present invention may provide the capability to use an ICVR service or an ICVR enabled device as a component in a security system that can start a dialog with an intruder or trespasser. In step 206, a user device, such as security device 108B may detect a security breach, such as the presence of an intruder or trespasser and start a dialog with the intruder or trespasser by transmitting audio messages to the intruder or trespasser and receiving voice communications from the intruder or trespasser. Security device 108B may provide ICVR provider system 102 with the received voice communications from the intruder or trespasser. In step 208, ICVR provider system 102 may provide additional audio messages to the intruder or trespasser and may transmit commands to VoIP provider system 104 to initiate a call to emergency services in response to the request. Likewise, such as system may take other actions, such as turning on/off the lights or closing the doors or the like to give the impression that there is a real person in the house, while the emergency services are being contacted.

In embodiments, the present invention may provide the capability to use existing devices, such as telephones, as ICVR enabled devices. For example, a user may use any of user devices 108A, 108B, 108N to establish communications with ICVR provider system 102. In this example, in step 202, a user may use, for example, telephone 108N, and establishes a communications session between telephone 108N and VoIP provider system 104. The user may enter predefined key sequence (such as “01”), which instructs VoIP provider system 104 to, in step 204, establish communications with ICVR provider system 102. In step 206, voice commands are provided to ICVR provider system 102 using telephone 108N. In step 208, ICVR provider system 102 may recognize voice information/commands from communications session and may perform functions in response.

For example, if a user wanted to listen to the radio or have any other hands free interaction with the device, the speaker phone may be used. Tus, in embodiments, the capability is provided to use available VoIP phones in combination with VoIP service providers to enable Intelligent Voice Recognition services available in the cloud. Similar functionality may be added to regular PSTN switches as well as cable phone services and cellular phones. High quality audio, also called HD Audio, is already available from many VoIP providers, and can be used to improve quality of recognition as well as played back audio streams, including music. Additional audio codecs may be added as needed.

In embodiments, the present invention may provide the capability to use an ICVR service or an ICVR enabled device as the front assistant for inbound calls, including providing a family/corporate directory service for the caller, as well as intelligent call screening for different purposes, including identification of solicited and fraudulent calls. For example, in an embodiment, in step 206, an incoming call to any of user devices 108A, 108B, 108N may be directed to ICVR provider system 102. In step 208, ICVR provider system 102 may provide additional audio messages to the caller and may ask the caller for identification and the reason for the call. Further, this may be done so that the caller may not recognize that it was not a real person that answered the call.

In embodiments, the present invention may provide the capability to use an ICVR service or an ICVR enabled device to access password protected phone features, such as voicemail, by using voice biometrics with or without a secret phrase. In embodiments, the present invention may provide the capability to use voice biometrics to limit access to restricted services, including child protection for example. In embodiments, the present invention may provide the capability to use the combination of third party voice biometrics with ICVR to provide secure or restricted services. For example, the ICVR service or ICVR enabled device may inform a phone service provider that a service requires authentication, the phone service provider would contact a biometric service provider and provides confirmation/rejection/trustworthiness back to the ICVR service or ICVR enabled device. In response, the ICVR service or ICVR enabled device may make a decision to allow the service or ask for a password.

In embodiments, features of the present techniques may include connection of communications between a VoIP Service Provider and an ICVR Provider, versus an end user device. Connection from an end user device, such as a phone, to a VoIP Service Provider. Connection from a VoIP Service Provider to registered intelligent user devices in combination with connection from an ICVR Provider to those user devices. Any cloud service provider may be connected to an ICVR Provider, not just a VoIP Service Provider. For example, an application provider may be connected to an ICVR Provider to enable text dictation using ICVR. Text-to-speech or voice reference searches may be performed. Different ICVR providers may be utilized. An ICVR Provider and a VoIP Provider may be the “same” provider.

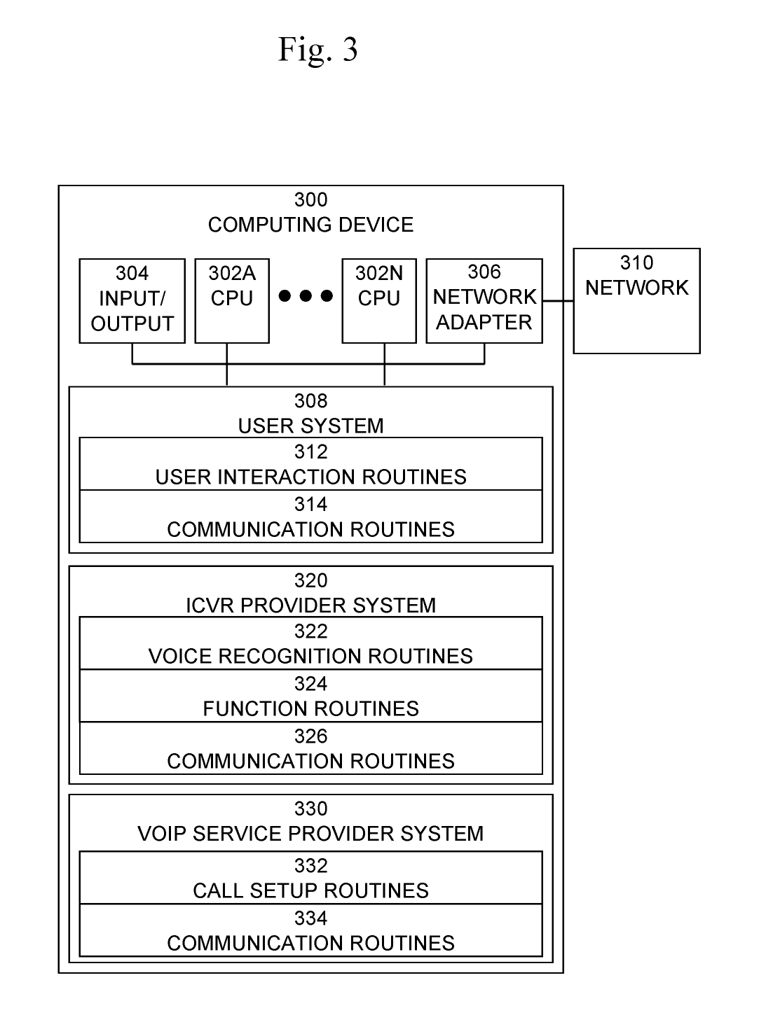

An exemplary block diagram of a computing device 300 that may be used to implement the processes described above is shown in FIG. 3. Computing device 300 is typically a programmed general-purpose computer system, such as a personal computer, workstation, server system, and minicomputer or mainframe computer. Computing device 300 includes one or more processors (CPUs) 302A-302N, input/output circuitry 304, network adapter 306, and memory 308. CPUs 302A-302N execute program instructions in order to carry out the functions of the present invention. Typically, CPUs 302A-302N are one or more microprocessors, such as an INTEL PENTIUM® processor. FIG. 3 illustrates an embodiment in which computing device 300 is implemented as a single multi-processor computer system, in which multiple processors 302A-302N share system resources, such as memory 308, input/output circuitry 304, and network adapter 306. However, the present invention also contemplates embodiments in which computing device 300 is implemented as a plurality of networked computer systems, which may be single-processor computer systems, multi-processor computer systems, or a mix thereof

Input/output circuitry 304 provides the capability to input data to, or output data from, computing device 300. For example, input/output circuitry may include input devices, such as keyboards, mice, touchpads, trackballs, scanners, etc., output devices, such as video adapters, monitors, printers, etc., and input/output devices, such as, modems, etc. Network adapter 306 interfaces device 300 with a network 310. Network 310 may be any public or proprietary LAN or WAN, including, but not limited to the Internet.

Memory 308 stores program instructions that are executed by, and data that are used and processed by, CPU 302 to perform the functions of computing device 300. Memory 308 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or Serial Advanced Technology Attachment (SATA), or a variation or enhancement thereof, or a fiber channel-arbitrated loop (FC-AL) interface.

The contents of memory 308 varies depending upon the function that computing device 300 is programmed to perform. In the example shown in FIG. 3, memory contents that would be included in each of a user device, an ICVR provider system, and a VoIP service provider system. For simplicity, these functions are all shown in FIG. 3. However, typically, each such function is implemented in separate hardware or software systems. Further, one of skill in the art would recognize that these functions, along with the memory contents related to those functions, may be included on one system, or may be distributed among a plurality of systems, based on well-known engineering considerations. The present invention contemplates any and all such arrangements.

In the example shown in FIG. 3, in embodiments in which computing device 300 is a user system, user system 308 includes user interaction routines 312 and communication routines 314. User interaction routines 312 include software routines to provide the capability for user system 308 to interact with a user. Communication routines 314 include software routines to provide the capability for user system 308 to communicate with one or more ICVR provider systems, and one or more VoIP service provider systems.

In the example shown in FIG. 3, in embodiments in which computing device 300 is an ICVR provider system, ICVR provider system 320 includes voice recognition routines 322, function routines 324, and communication routines 326. Voice recognition routines 322 include software routines to provide the capability for ICVR provider system 320 to receive and recognize voice and speech. Function routines 324 include software routines to provide the capability for ICVR provider system 320 to perform internal and external function in response to recognized voice and speech. Communication routines 326 include software routines to provide the capability for ICVR provider system 320 to communicate with one or more user systems, and one or more VoIP service provider systems.

In the example shown in FIG. 3, in embodiments in which computing device 300 is a VoIP service provider system, VoIP service provider system 330 includes call setup routines 332 and communication routines 334. Call setup routines 332 include software routines to provide the capability for VoIP service provider system 330 to setup calls and communications sessions with user systems and ICVR provider systems. Communication routines 334 include software routines to provide the capability for VoIP service provider system 330 to communicate using calls and communications sessions with user systems and ICVR provider systems.

As shown in FIG. 3, the present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. The task is like an envelope for the program in that it identifies the program with a task number and attaches other bookkeeping information to it. Many operating systems, including UNIX®, OS/2®, and Windows®, are capable of running many tasks at the same time and are called multitasking operating systems. Multi-tasking is the ability of an operating system to execute more than one executable at the same time. Each executable is running in its own address space, meaning that the executables have no way to share any of their memory. This has advantages, because it is impossible for any program to damage the execution of any of the other programs running on the system. However, the programs have no way to exchange any information except through the operating system (or by reading files stored on the file system). Multi-process computing is similar to multi-tasking computing, as the terms task and process are often used interchangeably, although some operating systems make a distinction between the two.

It is important to note that while the present invention has been described in the context of a fully functioning data processing system, those of ordinary skill in the art will appreciate that the processes of the present invention are capable of being distributed in the form of a computer program product including a computer readable medium of instructions. Examples of non-transitory computer readable media include storage media, examples of which include, but are not limited to, floppy disks, hard disk drives, CD-ROMs, DVD-ROMs, RAM, and, flash memory.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A communication method comprising:
establishing a communications session between either a user device and a telephone system or between a user device and voice recognition system;
if the communications session is between a user device and a telephone system, extending the communications session to include a voice recognition system;
if the communications session is between a user device and a voice recognition system, extending the communications session to include a telephone system;
providing voice or speech information to the voice recognition system from the user device; and
performing at least one function with the voice recognition system based on the provided voice or speech information.

2. The method of claim 1, wherein:
the provided voice or speech information is extracted from voice or speech information otherwise directed to the telephone system.

3. The method of claim 1, wherein:
the provided voice or speech information indicates a call recipient, and
the voice recognition system performs a function of initiating a call over the telephone system to the call recipient.

4. The method of claim 1, wherein:
the provided voice or speech information is an incoming call to the user device, and
the voice recognition system performs a function of screening the incoming call.

5. The method of claim 4, wherein screening the incoming call comprises:
determining if an Automatic Number Identification (AM) of the incoming call is approved, authorized, or verified; and
if the Automatic Number Identification (ANI) of the incoming call is not approved, authorized, or verified, ask the caller for information relating to the call.

6. The method of claim 1, wherein:
the provided voice or speech information is security information from the user device, and
the voice recognition system performs a function of verifying the security information.

7. The method of claim 6, wherein verifying the security information comprises:
biometrically verifying an identity of a speaker of the security information;
if the identity of the speaker of the security information is verified with a high level of trustworthiness, verifying the security information; and
if the identity of the speaker of the security information is not verified with a high level of trustworthiness, further verifying the security information.

8. The method of claim 1, wherein:
the provided voice or speech information is emergency information from the user device, and
the voice recognition system performs a function of requesting emergency services.

9. The method of claim 1, further comprising:
detecting a security breach; and
the voice recognition system performs functions of:
performing a dialog with a person involved in the security breach, wherein the provided voice or speech information is from the person involved in the security breach, and
requesting emergency services.

10. The method of claim 1, wherein:
the provided voice or speech information is information indicating a call to be placed from the user device, and
the voice recognition system performs a function of initiating the indicated call over the telephone system.

11. A computer program product for performing a communication method, the computer program product comprising a non-transitory storage medium and computer program instructions recorded thereon for performing the method comprising:
establishing a communications session between either a user device and a telephone system or between a user device and voice recognition system;
if the communications session is between a user device and a telephone system, extending the communications session to include a voice recognition system;
if the communications session is between a user device and a voice recognition system, extending the communications session to include a telephone system;
providing voice or speech information to the voice recognition system from the user device; and
performing at least one function with the voice recognition system based on the provided voice or speech information.

12. The computer program product of claim 11, wherein:
the provided voice or speech information is extracted from voice or speech information otherwise directed to the telephone system.

13. The computer program product of claim 11, wherein:
the provided voice or speech information indicates a call recipient, and
the voice recognition system performs a function of initiating a call over the telephone system to the call recipient.

14. The computer program product of claim 11, wherein:
the provided voice or speech information is an incoming call to the user device, and
the voice recognition system performs a function of screening the incoming call.

15. The computer program product of claim 14, wherein screening the incoming call comprises:
determining if an Automatic Number Identification (AM) of the incoming call is approved, authorized, or verified; and
if the Automatic Number Identification (ANI) of the incoming call is not approved, authorized, or verified, ask the caller for information relating to the call.

16. The computer program product of claim 11, wherein:
the provided voice or speech information is security information from the user device, and
the voice recognition system performs a function of verifying the security information.

17. The computer program product of claim 16, wherein verifying the security information comprises:
biometrically verifying an identity of a speaker of the security information;
if the identity of the speaker of the security information is verified with a high level of trustworthiness, verifying the security information; and
if the identity of the speaker of the security information is not verified with a high level of trustworthiness, further verifying the security information.

18. The computer program product of claim 11, wherein:
the provided voice or speech information is emergency information from the user device, and
the voice recognition system performs a function of requesting emergency services.

19. The computer program product of claim 11, further comprising:
detecting a security breach; and
the voice recognition system performs functions of:
performing a dialog with a person involved in the security breach, wherein the provided voice or speech information is from the person involved in the security breach, and
requesting emergency services.

20. The computer program product of claim 11, wherein:
the provided voice or speech information is information indicating a call to be placed from the user device, and
the voice recognition system performs a function of initiating the indicated call over the telephone system.
